(19) United States
(12) Patent Application Publication
(10) Pub. No.: US 2020/0375246 A1
(43) Pub. Date: Dec. 3, 2020

(54) HAND PIPE SLEEVE, A HAND PIPE, AND COMBINATION THEREOF

(71) Applicant: Session Corp., San Francisco, CA (US)

(72) Inventors: Esther Joy LeNoir, San Francisco, CA (US); Vinh Do Pho, San Francisco, CA (US); Camden Lee Foley, San Francisco, CA (US); Samuel Timothy Davis Bertain, San Francisco, CA (US)

(21) Appl. No.: 16/883,268

(22) Filed: May 26, 2020

Related U.S. Application Data
(60) Provisional application No. 62/853,570, filed on May 28, 2019.

(51) Int. Cl. A24F 9/16; F16L 59/02; A24F 3/00; A24F 9/14; A24F 5/00; A24F 1/32; A24F 5/04

(52) U.S. Cl. CPC A24F 9/16; F16L 59/021; A24F 3/00; A24F 5/04; A24F 5/00; A24F 1/32; A24F 9/14

(57) ABSTRACT

According to some examples, a hand pipe sleeve can include a body with a top end section and a bottom end section. In such examples, the bottom end section can include an opening. Additionally, the body of the hand pipe sleeve can include a sleeve well portion. The sleeve well portion can extend from the opening to the top end section. In some examples, the sleeve well portion can be dimensioned to be closely fitted around a bowl of a hand pipe when the hand pipe is inside the sleeve well portion.

### CROSS-REFERENCE TO RELATED APPLICATIONS

This application claims benefit of priority to U.S. Provisional Patent Application No. 62/853,570, filed May 28, 2019, the aforementioned application being hereby incorporated by reference in its entirety.

### FIELD OF INVENTION

Examples pertain to a hand pipe.

### BACKGROUND

A hand pipe can be utilized to combust consumable material, such as tobacco. The hand pipe can include multiple components, such as, a bowl, a chamber and a mouthpiece.

### BRIEF DESCRIPTION OF THE DRAWINGS

FIG. 1 illustrates an example hand pipe sleeve for a hand pipe;

FIG. 2 illustrates the example hand pipe sleeve of FIG. 1 with an example hand pipe;

FIG. 3 illustrates the example hand pipe sleeve of FIG. 1 with an example clip;

FIG. 4A illustrates an example hand pipe;

FIG. 4B illustrates a cross-sectional view of the example hand pipe of FIG. 4A;

FIG. 5A illustrates a cross-sectional diagram of the example hand pipe of FIG. 4A being inserted into the example hand pipe sleeve of FIG. 1;

FIG. 5B illustrates a cross-sectional diagram of enlarging an opening of the example hand pipe sleeve of FIG. 1 for inserting the example hand pipe of FIG. 4A into the example hand pipe sleeve of FIG. 1;

FIG. 5C illustrates a cross-sectional diagram of the example hand pipe of FIG. 4A in the example hand pipe sleeve of FIG. 1;

FIG. 6A illustrates a cross-sectional diagram of the example hand pipe of FIG. 4A in the example hand pipe sleeve of FIG. 1;

FIG. 6B illustrates a cross-sectional diagram of enlarging an opening of the example hand pipe sleeve of FIG. 1 for removing the example hand pipe of FIG. 4A out of the example hand pipe sleeve of FIG. 1;

FIG. 6C illustrates a cross-sectional diagram of the example hand pipe of FIG. 4A being removed from the example hand pipe sleeve of FIG. 1; and

Throughout the drawings, identical reference numbers designate similar, but not necessarily identical elements. The figures are not necessarily to scale, and the size of some parts may be exaggerated to more clearly illustrate the example shown. Moreover, the drawings provide examples and/or implementations consistent with the description. However, the description is not limited to the examples and/or implementations provided in the drawings.

### DETAILED DESCRIPTION

Examples provide for a hand pipe sleeve for a hand pipe that includes a well portion that is dimensioned to be closely fitted around at least a bowl of the hand pipe when the well portion of the hand pipe sleeve is covering the hand pipe. That way, when the well portion of the hand pipe sleeve is covering the hand pipe, consumable material (either pre or post combustion), such as tobacco, can be stored in the bowl of the hand pipe, without the consumable material spilling out of the bowl of the hand pipe or even out the hand pipe sleeve. Conventional carrying or hand pipe cases for hand pipes generally do not have cavities or well portions that are dimensioned to be closely fitted around the bowl of hand pipes. As such, any consumable material stored in the bowl of the hand pipe while the hand pipe is inside the cavity of the conventional carrying case, may spill into the conventional carrying case and even out of the conventional carrying case.

Additionally, examples provide for the hand pipe sleeve to be formed out of a heat resistant material to prevent heat from being transferred from the hand pipe to outside of the hand pipe sleeve when the hand pipe is inside the hand pipe sleeve. That way, shortly after the consumable material has been combusted in the hand pipe, the user may store the hand pipe into the hand pipe sleeve and not get burnt when handling the hand pipe sleeve with the hand pipe. Conventional carrying or hand pipe cases for hand pipes generally are not formed out of heat resistant material. As such, shortly after consumable material has been combusted in a hand pipe, the user may have to wait for some time for the hand pipe to cool down before storing the hand pipe in the conventional carrying case. Otherwise, the user risks burning and damaging the conventional carrying case, and even themselves.

### Hand Pipe Sleeve Description

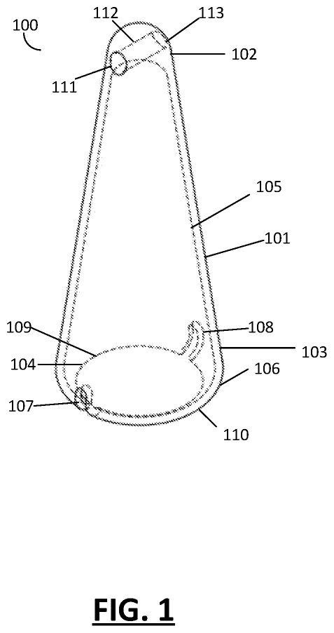

FIG. 1 illustrates an example hand pipe sleeve for a hand pipe. Hand pipe sleeve 100 can include body 101 with top end section 102 and bottom end section 103. Body 101 can have a thickness that defines an opening 104 at bottom end section 103 with sleeve well portion 105 that extends from opening 104 to top end section 102. In some examples, sleeve well portion 105 may be dimensioned to be closely fitted around a bowl of a hand pipe when sleeve well portion 105 is covering the hand pipe. That way, any consumable material (either pre or post combustion), such as tobacco, can be stored in the bowl of the hand pipe when sleeve well portion 105 of hand pipe sleeve 100 is covering the hand pipe, without the consumable material spilling out of the bowl of the hand pipe or even out sleeve well portion 105.

In various examples, body 101 can gradually taper from top end section 102 to bottom end section 103, such that a diameter of top end section 102 is smaller than a diameter of base 106 at bottom end section 103. Additionally, in some examples, the diameter of opening 104 may be smaller than the diameter of base 106 to form a lip or protruding edge that extends from an interior surface of sleeve well portion 105 towards a center of opening 104. In such examples, the diameter of opening 104 may also be smaller than a diameter of a base of the hand pipe. That way, when the hand pipe is inside sleeve well portion 105, the lip or protruding edge can securely hold the hand pipe in place within sleeve well portion 105.

Additionally, or alternatively, bottom end section 103 can include multiple slits to form multiple lips or protruding edges at bottom end section 103. For example, bottom end section 103 can be formed to include multiple narrow openings or slits, such as slit 107 and slit 108. The narrow openings or slits can extend from the protruding edge or lip at bottom end section 103 towards top end section 102 to form multiple lips or protruding edges at bottom end section 103, such as edge 109 and edge 110. In such an example, the width of the narrow openings or slits, such as slit 107 and slit 108 can vary. In some examples, each protruding edge or lip at the bottom end section 103, such as edge 109 and edge 110, can be the same size. In such examples, slit 107 and slit 108 can be positioned opposite from one another such that edge 109 and edge 110 are approximately the same size. In other examples, each protruding edge or lip at the bottom end section 103, such as edge 109 and edge 110, can differ in size. For example, slit 107 and slit 108 are not positioned opposite from one another so that edge 109 and edge 110 are different sizes.

In various examples, a user can manipulate edge 109 and edge 110 to make it easier for the user to insert or remove a hand pipe from hand pipe sleeve 100. For example, edge 109 and/or edge 110 can be bent or pulled from their original positions and away from the center of opening 104 to make opening 104 larger. That way, a user can more easily insert the hand pipe into sleeve well portion 105 or pull out the hand pipe from sleeve well portion 105. In some examples, body 101 can be formed out of a flexible material, such as rubber or silicone. In such examples, when the user stops manipulating edge 109 and/or edge 110, edge 109 and/or edge 110 can go back to its original positions. That way, after the hand pipe is inserted into sleeve well portion 105 and when the user stops manipulating edge 109 and/or edge 110, hand pipe can be securely held into sleeve well portion 105 by edge 109 and/or edge 110.

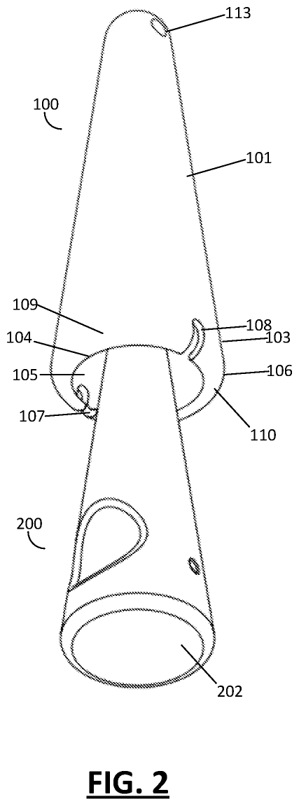

In various examples, the portion of sleeve well portion 105 at the top end section 102 can be dimensioned to fit a mouthpiece of the hand pipe, while the portion of sleeve well portion 105 at the bottom end section 103 can be dimensioned to fit the base and/or bottom end section of the hand pipe. That way, a user can insert the hand pipe, mouthpiece first, into opening 104 of hand pipe sleeve 100. FIG. 2 illustrates the example hand pipe sleeve of FIG. 1 with an example hand pipe. Hand pipe 200 is partially within hand pipe sleeve 100. Additionally, in examples where opening 104 is smaller than base 202, when hand pipe 200 is fully inside hand pipe sleeve 100, edge 109 and edge 110 can be in direct contact with base 202 and securely hold hand pipe 200 into hand pipe sleeve 100.

Body 101 can be formed out of heat resistant material to prevent heat from being transferred from a hand pipe that has been recently exposed to heat that is in sleeve well portion 105. In some examples, body 101 can be formed out of rigid heat resistant material such as rubber, or silicone. In other examples, body 101 can be formed out of malleable heat resistant material such as industrial felt, or leather.

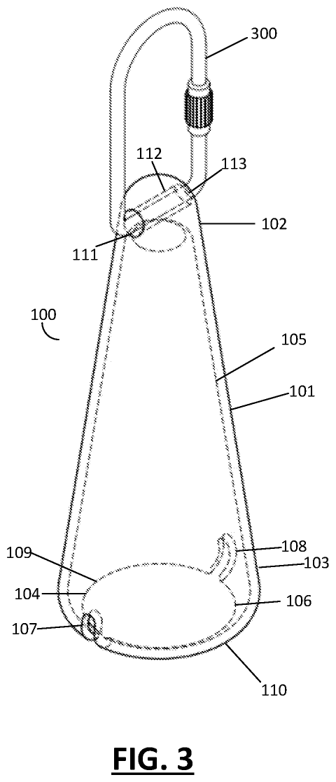

Additional features can enable a user to carry hand pipe sleeve 100 hands free, with or without the hand pipe in the hand pipe sleeve 100. For example, a portion of top end section 102 can have a thickness that defines an opening 111 at a front side of body 101 with cavity 112 that extends from the opening 111 to opening 113 of a back side of body 101. Opening 111, cavity 112 and opening 113 can be dimensioned to fit a clip (e.g., a carabiner). The clip can enable a user to secure hand pipe sleeve 100, with or without the hand pipe in the hand pipe sleeve 100, to the user (e.g., a belt loop of the user or a backpack of a user). In various examples, the top portion of sleeve well portion 105 can extend into cavity 112. In other examples, the top portion of sleeve well portion 105 and cavity 112 are separated by material that body 101 is formed out of. FIG. 3 illustrates the example hand pipe sleeve of FIG. 1 with an example clip. As illustrated in FIG. 3, opening 111, cavity 112 and opening 113 can be dimensioned to fit clip 300. Clip 300 can be used to securely clip hand pipe sleeve 100, with or without the hand pipe in hand pipe sleeve 100, onto the user (e.g., a belt loop of the user or luggage, such as a backpack).

### Hand Pipe Description

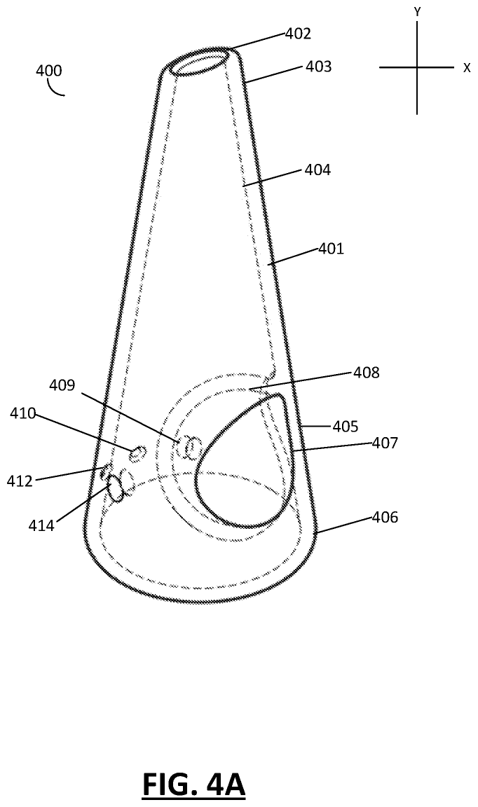

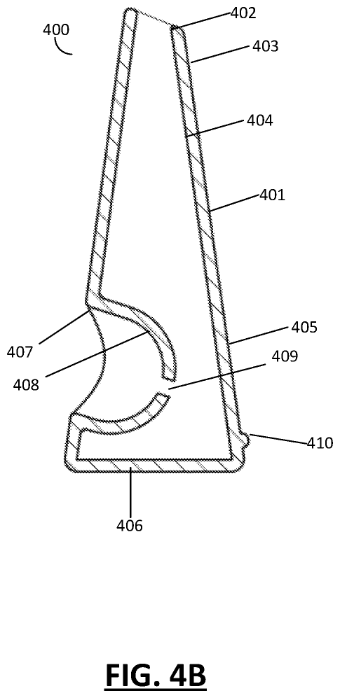

FIG. 4A illustrates an example hand pipe similar to hand pipe 200 of FIG. 2. Hand pipe 400 can include body 401, support 410, support 412, bowl well opening 409, and carb 414. Body 401 can be formed out of various materials, such as glass. For example, body 401 can be formed from borosilicate glass. In some examples, body 401 can be formed from other types of materials, such as, ceramic, silicone, metal, or any heat resistant material.

Additionally, body 401 can have a thickness that defines an opening or mouthpiece 402 at top portion 403 with well 404 that extends from mouthpiece 402 to the bottom portion 405. In various examples, mouthpiece 402 is acute with respect to the vertical axis (Y). For example, mouthpiece 402 may be angled at 15 degrees relative to the Y-axis.

In some examples, body 401 can gradually taper from top portion 403 to bottom portion 405, such that a diameter of mouthpiece 402 is smaller than a diameter of base 406 at bottom portion 405. Additionally, at bottom portion 405, body 401 can have a thickness that defines a second opening or bowl opening 407 at a front side of bottom portion 405 of body 401 with a recess or bowl well 408 formed from body 401 that extends from bowl opening 407 into well 404.

Bowl well 408 is where consumable material, such as tobacco, is combusted. In various examples, bowl well 408 can include an opening so that smoked produced from combusted consumable material in bowl well 408 can go to well 404. FIG. 4B illustrates a cross-sectional view of the example hand pipe of FIG. 4A. The cross-sectional view of hand pipe 400 includes bowl well opening 409. Smoke produced from consumable material being combusted in bowl well 408 can travel to well 404 through bowl well opening 409.

In examples where body 401 is conical or cylindrical in shape, hand pipe 400 can include additional features to ensure that hand pipe 400 can be prevented from rolling on a flat surface that hand pipe 400 is resting on. For example, body 401 can include support 410 and support 412. Support 410 and support 412 can enable hand pipe 400 to sit stably on a flat surface. For example, body 401 with support 410 and support 412 at bottom portion 405 can prevent body 401 from rolling when body 401 is sitting back side down with support 410 and support 412 making direct contact with the flat surface.

In various examples, bottom portion 405 of body 401 can include a carb. The positioning of the carb can be on any side of body 401, such as the left side or the right side. FIG. 4A, illustrates body 401 with carb 414. Carb 414 can enable a user to build up smoke in well 404, while the consumable material is being combusted in bowl well 408 and air/smoke is being drawn into well 404 from bowl well 408 through bowl well opening 409. For example, a user can cover carb 414 while drawing in smoke from the combusting consumable material to build up smoke in well 404. Additionally, the user can release carb 414 and inhale the smoke that has been built up in well 404 through mouthpiece 402.

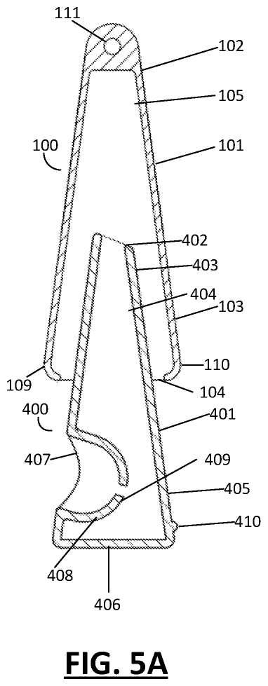

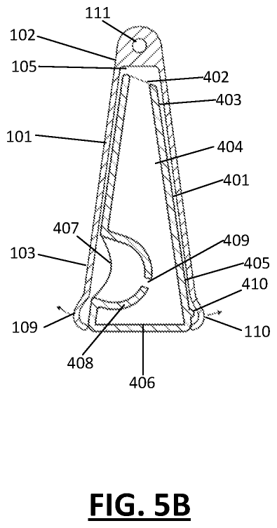

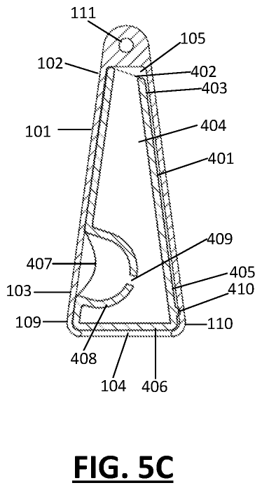

FIGS. 5A-5C illustrate cross-sectional diagrams of how the example hand pipe of FIG. 4A can be inserted into the example hand pipe sleeve of FIG. 1. FIG. 5A illustrates a cross-sectional diagram of the example hand pipe of FIG. 4A being inserted into the example hand pipe sleeve of FIG. 1. Hand pipe 400 can be inserted into sleeve well portion 105 of hand pipe sleeve 100 mouthpiece 402 first through opening 104 towards top end section 102.

FIG. 5B illustrates a cross-sectional diagram of enlarging an opening of the example hand pipe sleeve of FIG. 1 for inserting the example hand pipe of FIG. 4A into the example hand pipe sleeve of FIG. 1. In examples where bottom end section 103 of hand pipe sleeve 100 includes slits (e.g., slit 107 and slit 108), edge 109 and edge 110 can be manipulated to make opening 104 (not shown) larger. For example, edge 109 and/or edge 110 can be bent or pulled from their original positions and away from each other (e.g., away from a center of opening 104) to make opening 104 larger. That way, hand pipe 400 can more easily be inserted into sleeve well portion 105 of hand pipe sleeve 100.

FIG. 5C illustrates a cross-sectional diagram of the example hand pipe of FIG. 4A in the example hand pipe sleeve of FIG. 1. In examples where opening 104 has a diameter smaller than the diameter of base 406 of hand pipe 400, once hand pipe 400 is fully inserted into hand pipe sleeve 100 and edge 109 and edge 110 are in their original positions, edge 109 and edge 110 can be in direct contact with base 406 and securely hold hand pipe 400 into sleeve well portion 105 of hand pipe sleeve 100.

In various examples, sleeve well portion 105 can be dimensioned to be closely fitted around bowl opening 407. As such, consumable material can be stored in hand pipe 400 for future combustion by putting the consumable material into bowl well 408 when putting hand pipe 400 into hand pipe sleeve 100. Sleeve well portion 105 being dimensioned to be closely fitted around bowl opening 407 can reduce the risk of consumable material spilling out bowl well 408 and/or sleeve well portion 105. Additionally, after the consumable material has been combusted, the combusted consumable material can be stored for future disposal if at the time of combustion, disposal is inconvenient or improper (e.g., there are no waste disposal containers around). For example, combusted consumable material can be left in bowl well 408 of hand pipe 400 with the combusted consumable material can be placed into hand pipe sleeve 100. Due to sleeve well portion 105 being dimensioned to be closely fitted around bowl opening 407, the risk of the combusted consumable material spilling out of bowl well 408 and/or sleeve well portion 105 is low. That way, the combusted consumable material can be disposed when it is more convenient or proper (e.g., when the user finds a waste disposal container).

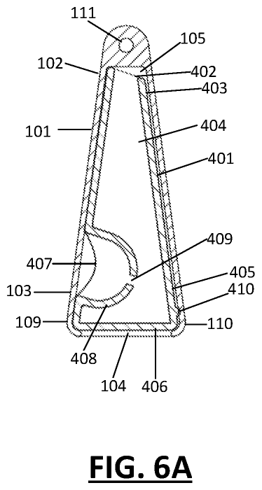

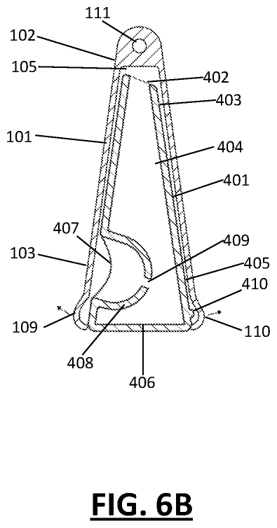

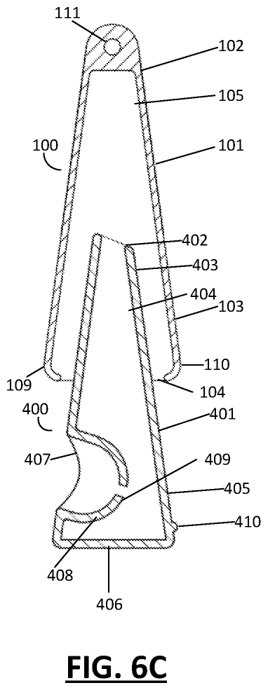

FIGS. 6A-6C illustrate cross-sectional diagrams of how the example hand pipe of FIG. 4A can be removed from the example hand pipe sleeve of FIG. 1. FIG. 6A illustrates a cross-sectional diagram of the example hand pipe of FIG. 4A in the example hand pipe sleeve of FIG. 1. As illustrated, opening 104 has a diameter smaller than the diameter of base 406 of hand pipe 400. As such, when hand pipe 400 is fully inserted into hand pipe sleeve 100, edge 109 and edge 110, in their original positions, can be in direct contact with base 406 and securely hold hand pipe 400 into hand pipe sleeve 100.

FIG. 6B illustrates a cross-sectional diagram of enlarging an opening of the example hand pipe sleeve of FIG. 1 for removing the example hand pipe of FIG. 4A from the example hand pipe sleeve of FIG. 1. Edge 109 and edge 110 can be manipulated so that opening 104 can be larger and make it easier for hand pipe 400 to be pulled out from sleeve well portion 105 of hand pipe sleeve 100. For example, edge 109 and/or edge 110 can be pulled or bent from their original positions and away from each other (e.g., away from a center of opening 104). That way, opening 104 is larger to make bottom portion 405 of hand pipe 400 more accessible for a user to handle and to pull hand pipe 400 out of sleeve well portion 105 of hand pipe sleeve 100.

FIG. 6C illustrates a cross-sectional diagram of the example hand pipe of FIG. 4A being removed from the example hand pipe sleeve of FIG. 1. Hand pipe 400 can be removed from sleeve well portion 105 of hand pipe sleeve 100 bottom portion 405 first through opening 104 away from top end section 102.

Although specific examples have been illustrated and described herein, it will be appreciated by those of ordinary skill in the art that a variety of alternate and/or equivalent implementations may be substituted for the specific examples shown and described without departing from the scope of the disclosure. This application is intended to cover any adaptations or variations of the specific examples discussed herein.

What is claimed is:

1. A hand pipe sleeve comprising:
a body including:
a top end section;
a bottom end section;
an opening at the bottom end section; and
a sleeve well portion that extends from the opening to the top end section, the sleeve well portion being dimensioned to be closely fitted around a bowl of a hand pipe when the hand pipe is inside the sleeve well portion.

2. The hand pipe sleeve of claim 1, wherein the bottom end section includes:
a protruding edge that extends from an interior surface of the sleeve well portion towards a center of the opening at the bottom end section.

3. The hand pipe sleeve of claim 2, wherein the bottom end section includes:
multiple slits.

4. The hand pipe sleeve of claim 3, wherein the multiple slits extend from the protruding edge towards the top end section.

5. The hand pipe sleeve of claim 1, wherein the top end section includes:
a first opening at a front side of the body;
a second opening at a back side of the body; and
a cavity that extends from opening 111 to opening 113.

6. The hand pipe sleeve of claim 5, wherein the cavity is dimensioned for a clip.

7. The hand pipe sleeve of claim 1, wherein the body gradually tapers from top end section to bottom end section.

8. The hand pipe sleeve of claim 1, wherein the body is formed out of a heat resistant material.

9. The hand pipe sleeve of claim 1, wherein the body is formed out of a flexible material.

10. The hand pipe sleeve of claim 1, further comprising:
the hand pipe.

11. The hand pipe sleeve of claim 10, wherein the hand pipe includes:
a hand pipe body, the hand pipe body comprising:
a top portion;
a bottom portion;
a second opening at the top portion, the top portion being angled with respect to a vertical axis; and
a well extending from the second opening at the top portion to the bottom portion.

12. The hand pipe sleeve of claim 11, wherein the bottom portion includes:
a front side;
a third opening at the front side; and
a bowl well that extends from the third opening into the well.

13. The hand pipe sleeve of claim 12, wherein the bowl well includes a bowl well opening at a bottom of the bowl well.

14. The hand pipe sleeve of claim 11, wherein the hand pipe body includes one or more support features.

15. The hand pipe sleeve of claim 14, wherein the bottom portion of the hand pipe body includes the one or more support features.

16. The hand pipe sleeve of claim 14, wherein the one or more support features includes a first support feature and a second support feature.

17. The hand pipe sleeve of claim 11, wherein the hand pipe body gradually tapers from the top portion to the bottom portion.

18. The hand pipe sleeve of claim 11, wherein the hand pipe body includes a carb opening on a side of the hand pipe body.

19. The hand pipe sleeve of claim 11, wherein the hand pipe body is formed from a heat resistant material.

20. The hand pipe sleeve of claim 11, wherein the hand pipe body is formed from borosilicate glass.
